(19) United States
(12) Patent Application Publication
(10) Pub. No.: US 2010/0315195 A1
(43) Pub. Date: Dec. 16, 2010

(54) METHODS AND APPARATUS FOR A DUAL POLARIZATION ANTENNA SYSTEM

(75) Inventors: Mark Duron, East Patchogue, NY (US); Richard Knadle, Dix Hills, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/483,508

(22) Filed: Jun. 12, 2009

(51) Int. Cl. G05B 19/00; H01Q 1/50; H01Q 21/00

(52) U.S. Cl. 340/5.1; 343/859; 343/727

(57) ABSTRACT

A dual polarization antenna system includes a dipole antenna oriented along a first plane (e.g., a horizontal plane), and a monopole antenna oriented along a second plane (e.g., a vertical plane) orthogonal to the first plane, wherein the monopole antenna is referenced to a V-null point of the dipole antenna.

### TECHNICAL FIELD

The present invention generally relates to antenna technology, and more particularly relates to dual polarization antenna configurations used in connection with mobile devices.

### BACKGROUND

Mobile devices, such as hand-held computers, RFID readers, and the like, are used in a variety of contexts. Such devices typically include one or more antenna elements to facilitate RF communication.

One popular class of antenna system includes two cross-pole antennas (either dipole or monopole) configured orthogonal to each other. Such systems are often employed in RFID readers, for example, in order to effectively interface with RFID tags, which may be deployed in a variety of different orientations.

It is desirable for mobile devices such as RFID readers to be relatively light and compact. However, currently known cross-pole antennas are unsatisfactory in that, to maintain antenna performance, they typically consume an undesirably large volume. That is, providing two dipole antennas orthogonal to one another consumes a significant amount of available space.

Accordingly, there is a need for compact cross-pole antenna systems for use with RFID readers and other mobile devices. Other desirable features and characteristics of the present invention will become apparent from the subsequent detailed description and the appended claims, taken in conjunction with the accompanying drawings and the foregoing technical field and background.

### BRIEF SUMMARY

A dual polarization antenna system in accordance with one embodiment includes a dipole antenna oriented along a first plane (e.g., a horizontal plane), and a monopole antenna oriented along a second plane (e.g., a vertical plane) orthogonal to the first plane, wherein the monopole antenna is referenced to a central V-null point of the horizontal dipole antenna.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic overview of an antenna system in accordance with one embodiment of the invention.

### DETAILED DESCRIPTION

The following discussion generally relates to improved methods and apparatus for antenna systems used in connection with applicable to mobile devices. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to antennas, RF communication, and the like need not and will not be described herein.

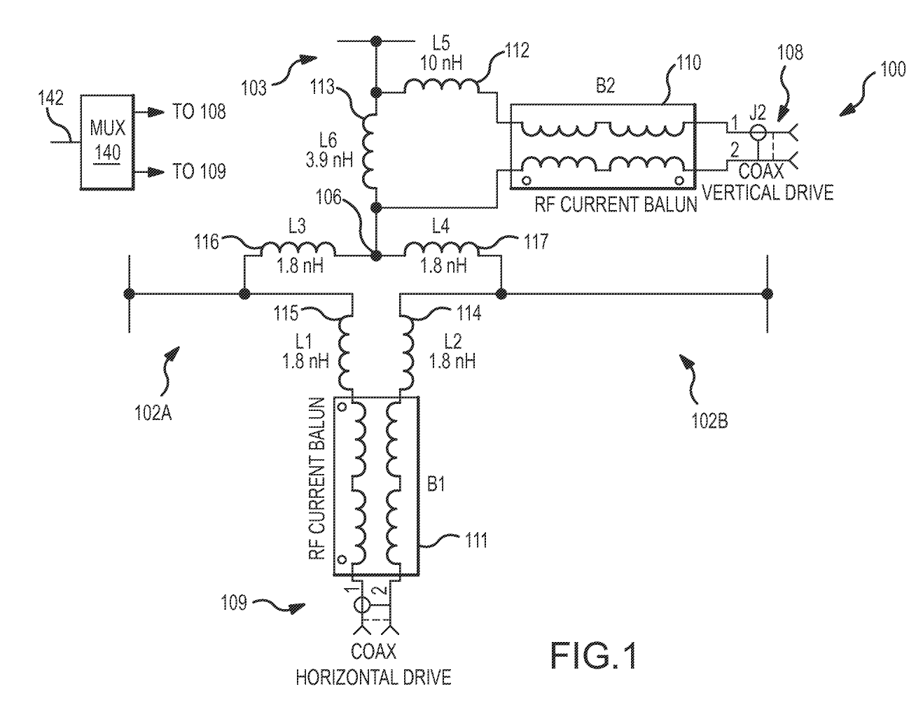

Referring to FIG. 1, A dual polarization antenna system (or simply antenna system) 100 generally includes a dipole antenna 102 oriented along a first plane (e.g., a “horizontal” plane) and a monopole antenna 103 oriented along a second plane orthogonal to the first plane (e.g., a “vertical” plane) such that the monopole antenna 103 is referenced to a central V-null point 106 of the horizontal dipole antenna.

More particularly, the V-null or virtual ground point 106 is a node lying in the center of an inductive shunt comprising two inductive elements 116 and 117, each of which is coupled to respective halves of dipole 102 (e.g., 102A and 102B) in a horizontal plane. Thus, V-null point 106 acts as the reference point for vertical monopole antenna 103. It will be appreciated that each dipole half 102A and 102B has an electrical length equal to ¼ of the wavelength of the RF signal.

A port (or vertical drive) 108 is coupled to vertical monopole 103 through a balun component 110, as is known in the art. Additional matching components, such as inductive elements 112 and 113, may also be incorporated. A second port 109 is coupled to the horizontal dipole antenna 102 through a second balun component 111 and inductive elements 114 and 115.

A multiplexer 140 is configured to alternately couple an RF I/O 142 to the first port 108 and second port 109 such that both antennas 103 and 102 function as monostatic RFID reader antennas. That is, both antennas are capable of bidirectional communication with any RFID tags within their respective ranges. In one embodiment, ports 108 and 109 include standard U.FL connectors configured to coupled with 1.13 mm coaxial cable.

As the physical length of the dipole halves 102A and 102B are short with respect to the one-half wavelength at which antenna 102 would like to resonate, it is heavily end-loaded, meaning that capacitive “top hat” devices are connected to the ends of dipoles 102A and 102B, in one possible embodiment. Because of the physical shortening of the radiating element, it's radiation resistance is very low, and therefore a matching structure is in place to transform the drive impedance down to the antenna impedance.

Furthermore, as the horizontal dipole halves 102 and 102B are resonating, they are each electrically ¼ wavelength long, and therefore transform the high impedance at the tips down to a very low impedance at the V-null center point 106. This creates an optimal counterpoise for the vertical monopole 103 to resonate against. If the monopole 103 is accurately centered at V-null point 106, the horizontal energy will be maximally isolated from the vertical energy. The radiated fields of each polarization will also be nulled with respect to each other.

Antennas 102 and 103 may be configured to operate within any suitable frequency range, e.g., a range of about 900 to 930 MHz. Further, antennas 102 and 103 may be fabricated in any suitable manner and using a variety of conventional materials. In one embodiment, antennas 102 and 103 are traditional printed copper structures formed on an integral single-layer polyimide on a 0.032″ dual-layer FR4 substrate.

In accordance with a preferred embodiment, antenna 103 has a substantially azimuthal toroidal radiation pattern and has a return loss of greater than 12 dB over the full operational bandwidth, and greater than 20 dB return loss at mid-band. Similarly, antenna 102 may have a substantially elevational toroidal radiation pattern and has comparable return loss.

In an exemplary RFID reader application, antenna system 100 is provided in a suitable RFID reader enclosure accompanied by a conventionally shielded component and RFID radio assembly. An integral ground shield, for example, acts to decouple the antenna system 100 from surface substrate materials that the portable device may be placed upon. Note, however, that the present invention is not limited to RFID applications, and may be used in any cross-pole antenna application where space and volume are a premium.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient and edifying road map for implementing the described embodiment or embodiments. It should be understood that various changes can be made in the function and arrangement of elements without departing from the scope of the invention and the legal equivalents thereof.

What is claimed is:

1. A dual polarization antenna system comprising:
a dipole antenna oriented along a first plane; and
a monopole antenna oriented along a second plane orthogonal to the first plane;
wherein the monopole antenna is referenced to a V-null point of the dipole antenna.

2. The antenna system of claim 1, wherein the first plane is a horizontal plane, and the second plane is a vertical plane.

3. The antenna system of claim 1, further comprising:
a first drive port coupled to the dipole antenna through a first balun component,
a second drive port coupled to the monopole antenna through a second balun component; and
a multiplexer configured to alternately couple an RF signal to the first drive port and the second drive port.

3. The antenna system of claim 3, wherein the dipole antenna comprises two dipole halves extending from the V-null point, and each have an electrical length equal to ¼ of the wavelength of the RF signal.

4. The antenna system of claim 3, further including an inductive shunt at the V-null point between the two dipole halves.

5. The antenna system of claim 3, further including an reactive shunt at the V-null point.

6. The antenna system of claim 1, wherein the RF signal is within the range of about 900 to 930 MHz.

7. The antenna system of claim 1, wherein the monopole antenna and the dipole antenna each function as a monostatic RFID reader antenna.

8. An antenna system for a mobile RFID reader, comprising:
a horizontal antenna structure comprising a first half dipole and a second half dipole extending from a v-null point, wherein the horizontal antenna structure is a first monostatic RFID reader antenna;
a vertical antenna structure comprising a monopole extending from the v-null point, wherein the vertical antenna structure is a second monostatic RFID reader antenna;
a first balun structure coupled to the vertical antenna structure;
a second balun component coupled to the horizontal antenna structure;
a first drive port coupled to the first balun component;
a second drive port coupled to the second balun component;
a multiplexer configured to alternately coupled an RF signal node to the first and second drive ports.

9. The antenna system of claim 8, wherein the first and second half dipole each have an electrical length equal to ¼ wavelength.

10. The antenna system of claim 8, further including an inductive shunt coupled to the first and second half dipoles from the V-null point.

11. The antenna system of claim 8, further including a first matching circuit coupled to the first balun component, and a second matching circuit coupled to the second balun component.

12. A method of communicating with RFID tags, comprising:
providing a dipole antenna oriented along a first plane;
providing a monopole antenna oriented along a second plane orthogonal to the first plane such that the monopole antenna is referenced to a V-null point substantially at the center of the dipole antenna; and
operating the dipole antenna and the monopole antenna as monostatic RFID reader antennas to communicate with the RFID tags.

13. The method of claim 12, including orienting the first plane as a horizontal plane, and orienting the second plane as a vertical plane.

14. The method of claim 12, including operating the dipole antenna and the monopole antenna within the frequency range of about 900 to 930 MHz.
